(19) United States
(12) Patent Application Publication
(10) Pub. No.: US 2005/0283395 A1
(43) Pub. Date: Dec. 22, 2005

(54) Enhancements to business research over internet

(76) Inventors: Jay William Lesandrini, Greenfield, IN (US); Margaret Paige Smith, Indianapolis, IN (US); Jane White, Fishers, IN (US)

Correspondence Address: THOMSON LICENSING INC., PATENT OPERATIONS, PO BOX 5312, PRINCETON, NJ, 08543-5312, US

(21) Appl. No.: 11/213,500

(22) Filed: Aug. 26, 2005

Related U.S. Application Data
(62) Division of application No. 09/792,208, filed on Feb. 22, 2001.
(60) Provisional application No. 60/239,348, filed on Oct. 11, 2000.

(51) Int. Cl. G06F 17/60

(52) U.S. Cl. 705/10

(57) ABSTRACT

Enhancements to a business method for performing research over the internet are presented. In one aspect, a user is requested to select a ratable object. The user is then requested to select a color to associate with the selected ratable object, after the selected ratable object has been viewed by the user so that research result is obtained. In another aspect, a community web site is provided for a plurality of users for a first targeted industry. User information for the plurality of users of the community web site are gathered. Thought leaders among the plurality of users of the community web site are then identified. In yet another aspect, as a way to entice users to a website for gaining research information, a user is allowed to select an advertisement from a plurality of advertisements and the user is allowed to send an email containing a link to the selected advertisement.

### CROSS REFERENCE TO RELATED APPLICATION

This application claims the benefit of a U.S. Provisional Application, Ser. No. 60/239,348, filed Oct. 11, 2000, in the names of the present inventors.

### FIELD OF THE INVENTION

The present invention generally relates to business research over internet, and more particularly to a system and method for enhancing business research.

### SUMMARY OF THE INVENTION

A website that encompasses human-to-human interaction to create a sense of community about the target industry would be built to create and maintain a database people to be used as research participants for the target industry. The interactivity will promote participation, and use of viral marketing and affiliate programs will constantly refresh the database. The site would also be used to gather empirical data that would be used to generate reports for the target industry, creating credibility for our target industry.

In one embodiment, Virtual Anthropology™, a way to unobtrusively observe people's actions in cyberspace, is used to observe activities of users on the website in order to generate reports.

Another aspect of the present invention is to identify “thought leaders” of the websites through, for example, the registration process. The present inventors have recognized that one consumer's opinion does not equal another one. A thought leader is a person who has the ability to affect other people's opinions, purchasing decisions, etc. A thought leader is a person who shares his experiences and opinions (both negative and positive) regarding advertisements, products, services, brands, etc., with other people. Therefore, although two people might have the same opinion, more people may hear a thought leader's opinion or experience whereas a thought follower would keep his opinion to himself, which lessens the impact. Therefore, one embodiment of the present invention is to provide a research service to identify and gain access to thought leaders.

Our initial business model is aimed at the adverting industry. The Internet site targeting the Advertising industry is referred to as Ad2Cents or A2C in this application. The research company is referred to as AdInsights. This business model can be extended to any industry, such as video gaming, consumer electronics, restaurant services, etc.

As the business model is extended, the costs diminish because the technology required will already be in place and the databases will overlap somewhat.

Most research companies do not specialize in a particular industry—they have a “Walmart” approach to research; a little of everything. Some may specialize in a particular medium (e.g., Media Metrix focuses on research about websites, and Nielsen specializes in the television broadcast medium), but do so across industries. Specialization leads to credibility with our niche market, economies of scale in conducting research, higher quality services and research, and an opportunity for publicity. When you specialize, traditional media often looks to you for information and quotes your company when publishing an article about a specific subject.

The use of a community site targeted to an industry solves the problem of how to effectively populate and maintain a database for research purposes, and how to effectively use the internet, for example, as a research tool.

There are several advantages to recruiting people via this entertainment, community site: you are recruiting people who already have an interest and are at the site by their choice. The community features and points-based rewards system for activities completed on the site give users incentive to return; thus the database has a higher retention rate and remains current. Viral marketing will assist in refreshing database with new users.

Internet-based research offers a faster method of conducting research but so far has not gained credibility because companies have removed the human component instead of using the internet as a tool. Concentrating on niche markets gives us speed and credibility with the specific industry, and provides a specialized service for them. Using the internet as a tool, but focusing on the personal relationship with each research client (an representative from an advertising agency) allows us to give high-quality, expertly analyzed data, from participants all over the country, in a timely manner.

Most research companies buy lists from other companies (often outdated) or generate lists via telephone recruiting. Traditional methods of purchasing lists and telephone recruiting are inefficient—lists are outdated, have low retention and response rates.

Telephone recruiting is not efficient because you are interrupting people in their homes without knowing if they have any desire to participate in research. Most people don't like to receive cold calls such as this.

An extensible business model, which uses an industry-specific internet site to mind and maintain a database according to the principles of the present invention, may be used efficiently to conduct research for the target industry.

One exemplary industry of the present invention is to target the Advertising Industry. The exemplary consumer information gathering web site is referred to as ad2cents (A2C). The research company or web site that conducts research using A2C participants (who are in a database) is referred to AdInsights (AI).

According to the principles of the present invention, the present business model is extensible to other industries, for example, a site with interactivity, entertainment, and community features for people interested in video gaming would enable a database to be built with people who are interested in that niche market. That database would then be used to conduct research for video gaming industry.

Ad2cents

In order to build and maintain a database of consumers to participate in research services (focus groups, surveys, etc,) we would build a community (internet site) which would feature advertising as entertainment. The site would contain many interactive features, such as:
view commercials
rate commercials
write your own reviews of commercials
chat rooms
message boards
moderated forums
make and submit your own commercials spoof commercials
play on-line games
email commercials (vs. greeting cards) to friends

In addition, a progressive registration process would be used to get user info (demographics). The more info a user gives us, the more areas of the site he or she can participate in, and the more points he or she will receive. For example, no information is necessary to view commercials and rate commercials. If you want to view other people's opinions and comments about a commercial, an e-mail address is required. Full registration would also be used to ask questions (for examples, determined by system designers, anthropologists, sociologists, and/or psychologists) that would identify the aforementioned thought leaders.

Users could also e-mail favorite commercials to friends, thus utilizing viral marketing to help populate the database.

By having a site dedicated to advertising, we show our commitment to the ad industry. This site also serves as a source of informal, unsolicited data, which can be used to create marketing reports to strengthen our credibility with the ad industry.

Also, as the business model is extended, the costs of building another database diminish because the technology required would already be in place and the databases will overlap somewhat. Ad2cents would not be publicly associated with AdInsights. It would appear as a stand-alone site, although the database would be used to provide participants for AdInsights' research.

AdInsights

This database would then be used to conduct research for the advertising industry. “Clients” (ad agencies, specifically, account executives and account planning managers, and advertisers) would access a different site to find out about research services. The client site is referred to as AdInsights. AdInsights clients can access their website and order different types of services. The majority of services may focus on qualitative research (the emotions, how and why) vs. quantitative research that is linear and requires critical mass. Services include, but are not limited to:

Thought Leader Access: targeted qualitative insights

Adfusion: Proactive research that anticipates future platforms. Guides agencies and advertisers in creating a message that works on new and emerging media platforms.

Dual Radar (DR. Brand): Focuses on tracking (brand health). Uses dual methodologies to create a comprehensive report on brand image and placement.

Syndicated Research: studies that focus on one particular arena. Targeted clients are recruited to fund the study before it is conducted. Some of the information is used for general reports while the client receives a certain amount of proprietary research.

The company “Ad Insights” would employ data miners to collect the raw data and expert research analysts

Hence, enhancements to a business method for performing research over the internet are presented. In one aspect, a user is requested to select a ratable object. The user is then requested to select a color to associate with the selected ratable object, after the selected ratable object has been viewed by the user so that research result is obtained. In another aspect, a community web site is provided for a plurality of users for a first targeted industry. User information for the plurality of users of the community web site are gathered. Thought leaders among the plurality of users of the community web site are then identified. In yet another aspect, as a way to entice users to a website for gaining research information, a user is allowed to select an advertisement from a plurality of advertisements and the user is allowed to send an email containing a link to the selected advertisement.

### BRIEF DESCRIPTION OF THE DRAWING

FIG. 1 is a graphical representation of the business method model according to the principles of the present invention.

FIG. 2 illustrates how this model may be extended.

FIG. 3 gives more specific examples of how this model may be extended to specific industries.

FIG. 4 illustrates how the model may be applied to advertisement industry.

FIG. 5 illustrates how this model may be extended to other industries but the database may be shared among industries.

FIG. 6 is a exemplary system architecture of the present invention.

FIG. 7 is an exemplary web page of a consumer advertisement feedback gathering web site.

FIGS. 8A and 8B illustrate how user profile information may be gathered.

FIG. 9 shows how user rating of an advertisement may be gathered.

FIG. 10 shows an exemplary web page of how a subscribing client may access the research information web site.

FIG. 11 shows a color wheel according the principles of the present invention.

FIG. 12 is an illustration of a game.

FIG. 13 is an illustration of an event schedule and chat forum.

### DETAILED DESCRIPTION

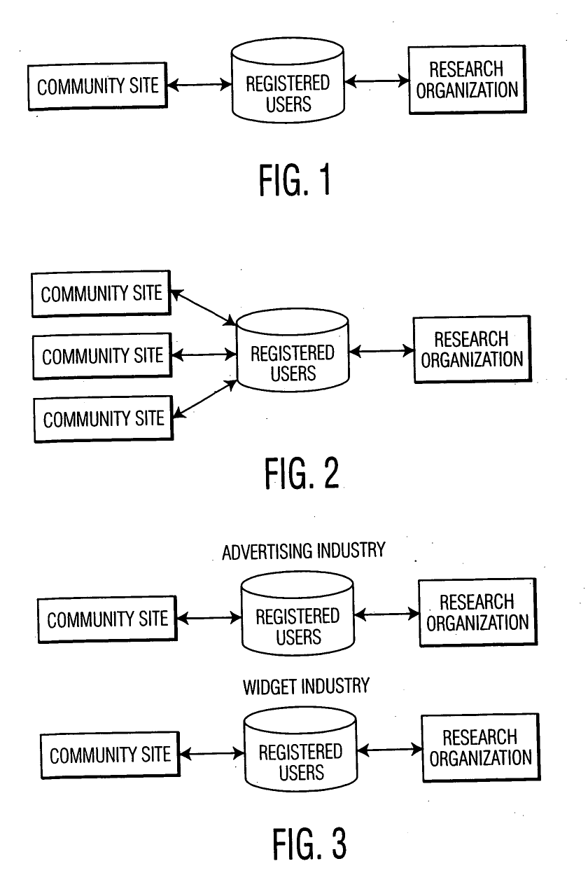

FIG. 1 shows graphically the present business method model in the generic form. This model can be extended in several different ways, as shown in FIG. 2. New community sites will increase the number of registered users. New research organizations can be created, or different research services can be added to the existing organization. In addition, this model can be moved from the advertising industry to entirely different industries.

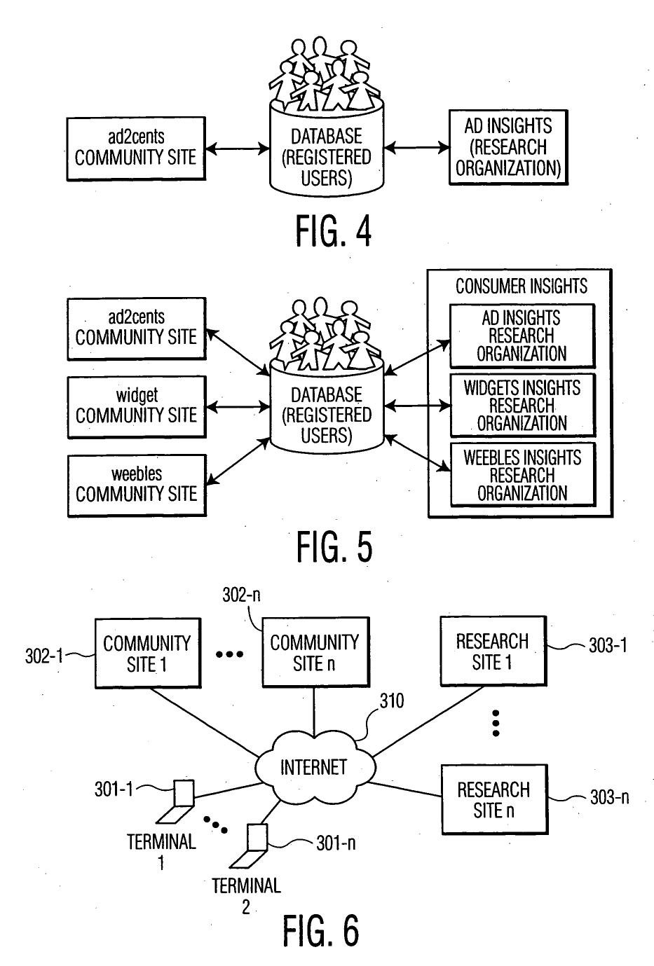

An example of the business model according the principles of the present invention is a web site for users to evaluate advertisements (e.g., A2C), and another web site (e.g., Ad Insights) that provides access to analyzed data from the first web site to subscribing clients of the research information, as shown in FIG. 4

Ad Insights (AI), the web site for analyzing and reporting viewer feedback information was conceived to utilize the A2C community in marketing research. After users register on A2C, they become part of a pool of candidates interested in critiquing advertisements and participating AdInsights services (focus groups, surveys, etc.).

High bandwidth, high quality entertainment sites are growing in popularity as the penetration of broadband grows in North America. A2C is the perfect example of a site capable of utilizing broadband access, with high quality commercials presented in excellent quality video format. A number of sites today are only available in broadband, taking advantage of the fantastic content possibilities (such as full-motion video, interactivity, and high quality sound) that broadband brings to the table.

While A2C will have extensive capabilities, here are examples of some of the site features:

Users will be able to:
View commercials in a variety of categories
Rate the commercials
Comment on the commercials
See other people's ratings and comments
Play on-line games
Participate in forums and chat rooms
Earn points for participating on the site
Submit their own parody commercials

A full description of the A2C features are described in more detailed below.

The present inventors discovered an unfilled niche in marketing research—advertisers currently do not have a time-efficient method to test advertising concepts during the earliest stages of development. The length of time it takes for a research study to be commissioned means that most advertisers wait until a concept is fully developed or already being broadcast before it is tested. This niche is a perfect opening into the $5.7 billion advertising research market in the United States alone. FIG. 1 shows graphically the present business method model. This model can be extended in several different ways, as shown in FIG. 2. New community sites will increase the number of registered users:

New research organizations can be created, or different research services can be added to the existing organization. In addition, this model can be moved from the advertising industry to entirely different industries. In this way, a company or organization can utilize the A2C/AI model in industries that will feed back into that company or organization's core services and products. FIG. 3 shows this concept of duplicating the present business method to other industries where each industry will have its own dedicated database.

A good portion of the A2C/AI business model is driven by incentives for participation. As an incentive, a company can offer its products through a rewards program. The company will have continuous access to the research offerings of AI. While this initially applies to marketing, the company will have the ability to carry the A2C/AI research model into new sectors. These sectors may have duplicated or cross-over consumers. This would allow the opportunity for sharing of the user data base, increase the efficiency and cost of the whole research process, as shown in FIG. 5.

Ads2cents.com (A2C) Description

A2C is a combination of several Internet features, with the unique approach of delivering advertising as entertainment. A2C will create a community that gathers to view entertaining advertisements, rank the advertisements, and provide feedback on the advertisements.

One way the value of A2C will be measured is in how many users it drives to the site and who register in the database, but more importantly, the ability to identify thought leaders who will participate in research for ADinsights. In another example, people who participate in research may be paid cash quarterly, whereas ad2cents activity gives users points and/or products as discussed above. In addition, the traffic and feedback from users on the Internet site will provide AI with useful data to analyze in creating reports, by using Virtual Anthropology™.

Advertising can be a successful entertainment medium for the masses when it is delivered in a format that the user chooses, and when they choose to view it. An informal study found that over 60% of respondents found advertising informative and/or entertaining. Sixty-one percent said that they would like to view humorous advertisements at their request.

Advertising is increasingly a part of society and people have grown familiar with it over the years. To keep people's interest, advertisers have increased the entertainment quotient in advertisements. Humor or entertainment is quickly becoming the benchmark by which successful advertisements are judged. Certain ads, such as the Budweiser “Wuzzup” series or the Taco Bell Chihuahua, become a part of pop culture. People wear clothing accessories that sport the latest commercial icon, talk about good commercials around the water cooler.

At the same time, high bandwidth, high quality entertainment sites are growing in popularity as the penetration of broadband grows in North America. Ad2ents is the perfect example of a broadband site, with high quality commercials presented in a television based video format.

A2C will broadcast, categorize and build a community around advertisements. As users view the advertisements, they will have the ability to express their opinion through ranking, feedback and discussion groups. This type of community interaction encourages repeat visits and site loyalty. It also provides a service to the users in exchange for gathering their personal information. A full description of the site features follows in this document.

Ultimately, the purpose of A2C is to gather data and populate a database of users that are interested in ranking and evaluating advertisements. A2C may not be profitable in and of itself; its value will be measured in the number of registered users the site creates, the level of repeat visitors, and most importantly the quality of the data base participants that would be considered thought leaders who would participate in research for AdInsights. Therefore, the two sites are closely coupled.

### Site Functionality

The following areas comprise some examples of site's functionality:
Progressive Registration
View commercials
Rate commercials
Comment on commercials
Submit commercials
Points-based rewards
Online games
E-mail commercials to friends
View other people's comments and ratings
Participate in forums and chat rooms
Commerce

Each function is described below:

Progressive Registration

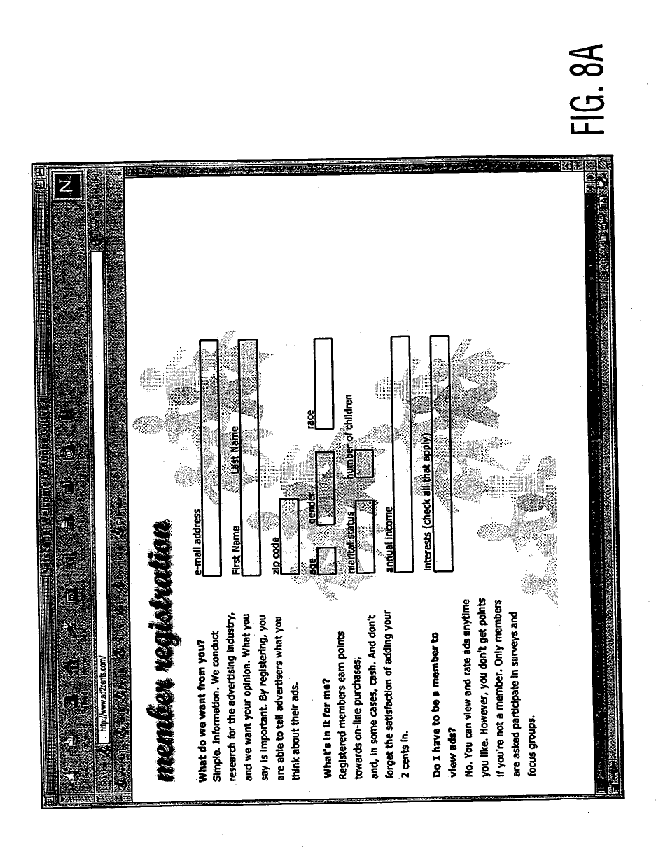

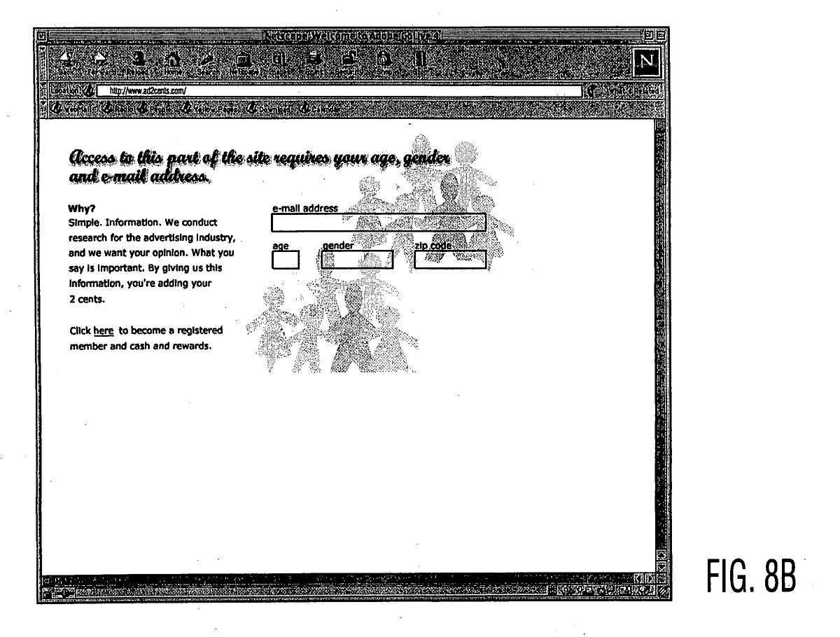

A progressive registration process would be used to get user info (demographics). The more info they give us, the more areas of the site they can participate in, and the more points they can earn (described in points-based rewards section). For example, no info is necessary to view and rate commercials. If you want see other people's comments and ratings of a commercial, however, you have to give your e-mail address. If you want to participate in forums or chats, you have to provide more information (for example, your email address, gender, age, zip code). Full registration would include questions about willingness to participate in focus groups, surveys, etc. for the ad industry. FIGS. 8A and 8B illustrate the progressive registration process according to the principles of the present invention. FIG. 8A shows an example of first level of registration required for accessing a first level of feature of the A2C web site. FIG. 8B shows the additional level of user profile information the user must provide to gain additional access to the web site.

View Commercials

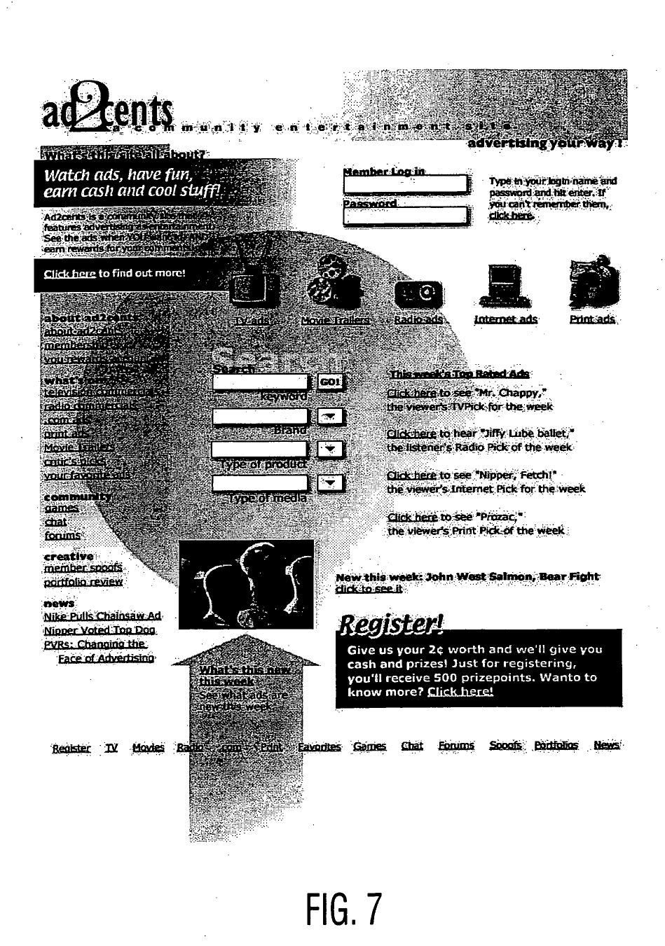

The main feature of the site is to view commercials. The site will feature multiple categories of commercials, including humorous, dramatic, Best of's, foreign and other categories. Also, commercials may be categorized by media type, such as television, radio, print, internet, billboard, ads, and movie trailers etc., as shown in FIG. 7. Viewing commercials will require QuickTime, or another video-viewing tool. Information for the viewing tool and complete download information will be provided on the Internet site.

Rate Commercials

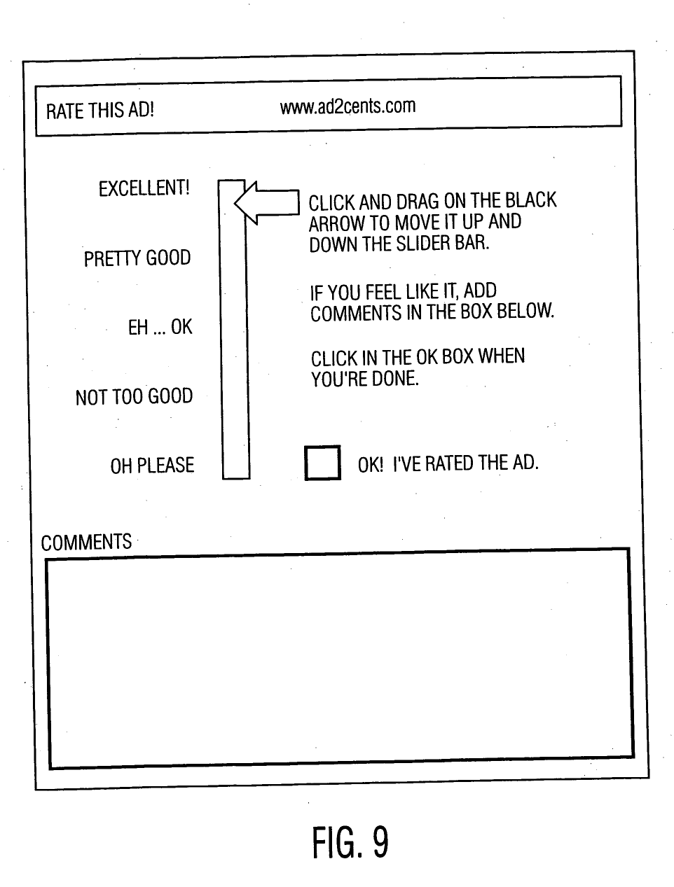

A screen to rate the commercial will appear when the ad has finished playing (in the case of television or radio), or several seconds (length to be determined later) seconds after its displayed (print, internet). If they fully register, including a user name and password, they will be able comment on any commercial, earn points for viewing commercials, and communicate with other members of A2C. FIG. 9 shows how the rating information may be gathered from an exemplary web page.

Comment on Commercials

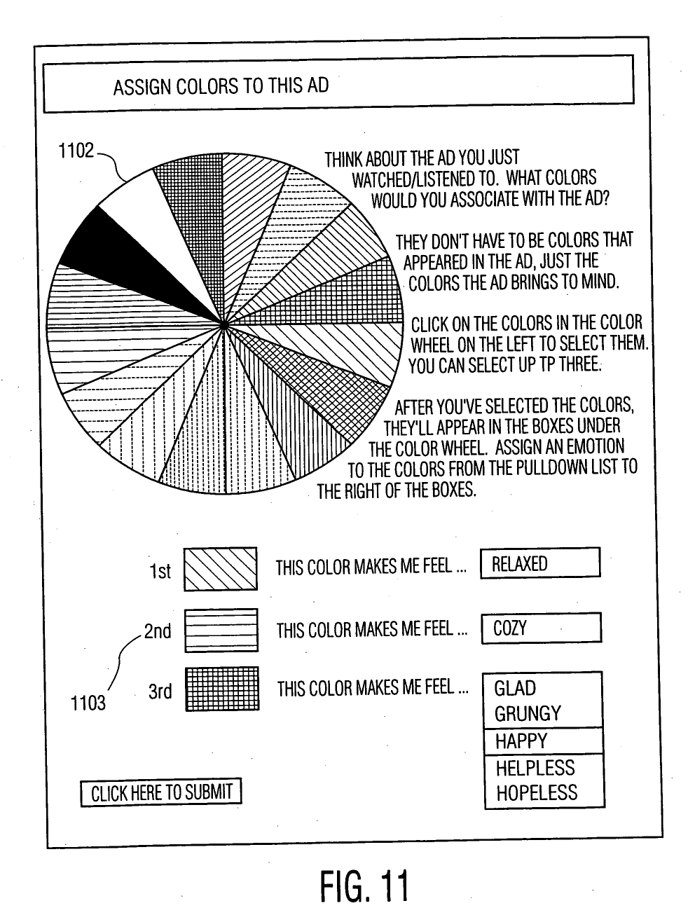

Registered users will be able to comment on the commercials in a number of ways:
Numerical rating system
Multiple choice polls: After viewing a commercial, users may be given multiple choices via a survey format.
Original comments on commercials: The users will be able to give their original comments on the site.
Color coding: in this scenario, a user would be asked to identify the color(s) from a color wheel that best identify their feeling towards an advertisement. The present inventors recognize that color stimuli can make people have multiple feelings. Therefore, users will have the opportunity to pick colors from a color wheel 1102 for colors which they may associate with an ad they have just watched, as shown in FIG. 11. They may also rank the colors by percentages (for example, a user might pick red, green, and lilac from the color wheel and give the following percentages: red: 60%, green 30%, lilac 10%). In addition, selection screen 1103 appears asking them to enter what those colors mean to them (for example, red: romantic; green: alive; lilac; soft and flowing), as shown in the bottom of FIG. 11. This type of rating would give valuable insights into use of color for logos, ads, etc.
   Submit Commercials

Users will be able to submit original commercials that they have created. Part of the site will be dedicated to instructions and tutorial that will give users hints on how to create their own commercial for the site. This feature will encourage more people to participate in submitting spoof commercials or their own commercials.

Points-Based Rewards

Users will be able to earn points for registering, viewing commercials, rating commercials, playing on-line game, participating in chat rooms and forums, and recommending commercials to others. The points system can work with a variety of possible partners, including RCA products, as part of a broad offering of possible points partners that include internet points companies (mypoints, flooze, etc). An important distinction between this points-based rewards system and others that ask people to complete surveys is that a2c participants earn points for everything they do on the site, whereas other sites only enter the person into a drawing for a prize each month.

Online Games

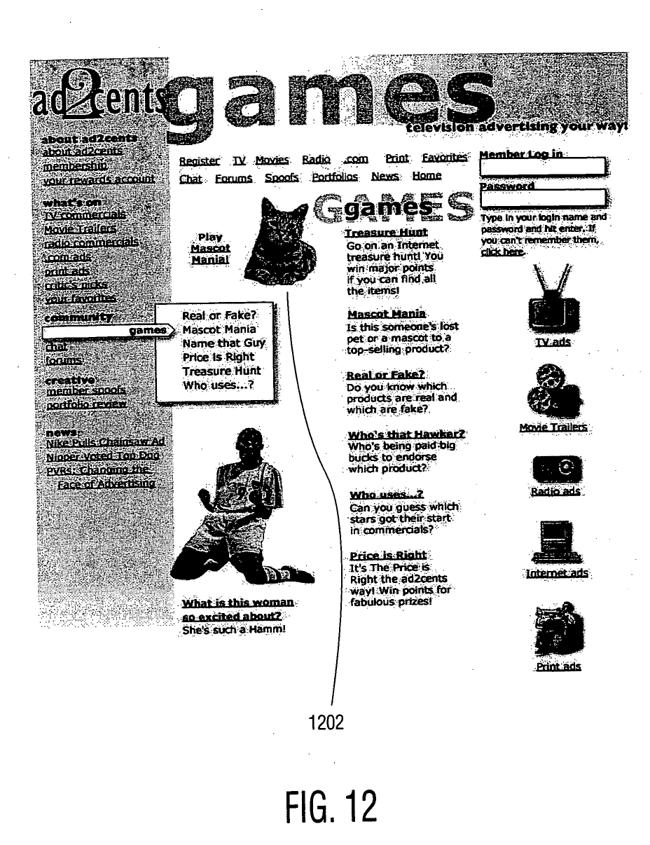

The site will feature a number of online games, bringing in elements from the commercials that are on the site. These games will also earn users points and will prompt users to view commercials to complete various games. For example, one game may be a “Where are they now?” trivia game, in reference to popular characters in advertisements. Another example is illustrated in FIG. 12, called Mascot Mania. Participants are asked to select the correct name of the mascot, the brand, the company, and the type of product it represents, after they select “play mascot mania” icon 1202.

E-mail Commercials to Friends

One of the greatest features of the Internet is the ability to draw attention to content by simply sending an e-mail with a URL in it. The A2C site will entice registered users to e-mail a commercial URL to any individual, thus drawing attention to the commercial and the site itself. The URL will also include functionality for the new viewer to register on the site, as well as a brief explanation of the site and its points-based reward system.

A2C will also offer a rating or categorizations that suggest appropriate occasions in which to send specific commercials (“greeting commercials” instead of greeting cards). For example, the Nike advertisement with Michael Jordan explaining how many shots he's missed and how many times he's failed has the tagline “I fail, therefore, I succeed” would be categorized as motivational and/or send to colleague or friend who is facing difficult challenges at work or in sports. Other commercial such as Budwiser's “Whazzup” may be categorized as humor, for example.

Affiliate Programs

A2C will also include an affiliate program that will allow users to register to post links to the various commercials and earn points for drawing users to the site.

View Other People's Comments and Ratings of Commercial

Another feature of the site is to find out what other people think about a commercial. This human desire to know how other people's opinions differ (or are the same) from their own will promote registration and might prompt the user to participate in forums and/or chat rooms.

Participate in Forum and Chat Rooms

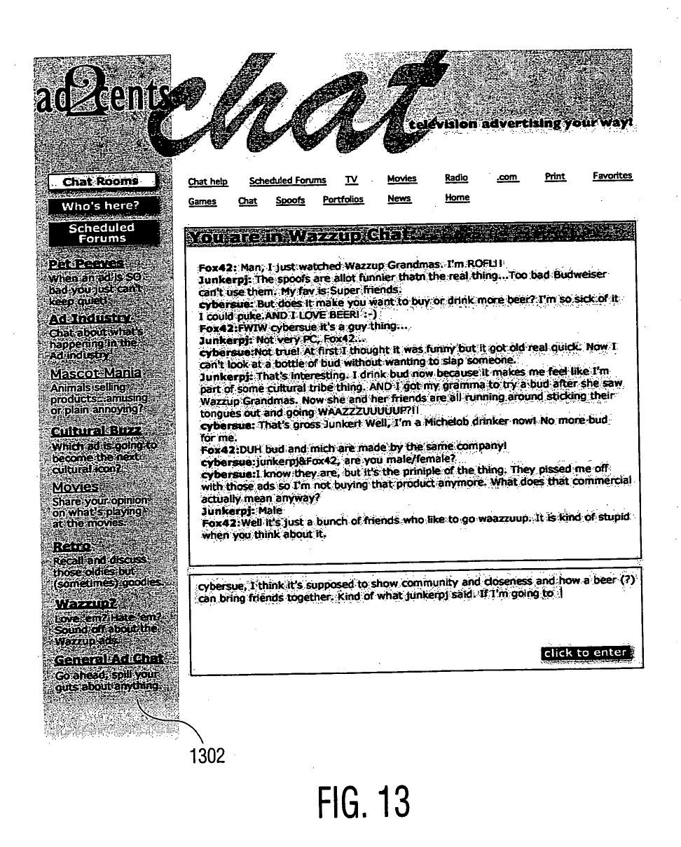

As a member of A2C (full registration and platinum points user) one will be able to participate in chat room that will be divided into categories. FIG. 13 Members will also be able to participate in scheduled forums. 1302 of FIG. 13 shows a schedule of upcoming chat forums that are organized, and may be moderated.

Commerce Opportunities

As previously mentioned, the site will not have substantive revenue generating opportunities. The value of A2C is measured strictly in its ability to create a community of registered users that will participate in surveys and focus groups.

However, one possible source of revenue is merchandising. There will be opportunities to sell items related to commercials. For example, hot commercials often offer merchandise, such as Budweiser hats, Taco Bell t-shirts or other items that have crossed over into popular culture. A2C will see value in this initiative because of the service it provides consumers, instead of a financial return.

### System Description

Entertainment

At the core of A2C will be the delivery of advertisements to users. This delivery is critically important, especially given current limitations on the Internet such as bandwidth concerns and compatibility issues. A2C will need to make every effort towards making the display of advertisements as user-friendly and painless a process as possible. A2C will make the appropriate settings as soon as a user chooses his connection type: 56K modem (the most common connection for at-home users), cable modem (emerging in popularity), ISDN (small offices, some at home users), T1 (large corporations with systems people in place), etc. That is, when users choose their connection type, A2C will automatically chooses the optimal format (e.g., resolution, display size) for their internet connection in order to make the download and display as fast as possible. For users with broadband connections, a high resolution streaming video may be sent, where as for a dial-up users, lower resolution streaming video may be used. Considerations here are quality, size (quantity of pixels), audio accompanied video, and the total number of viewers concurrently using the Internet site:
Quality will be the biggest contributor of the bandwidth necessary to stream a clip. It is crucial that an ‘optimal’ viewing quality be defined early so an adequate video compression algorithm can be chosen.
Display Size. Limiting the size of the streaming clip will significantly impact the time and bandwidth necessary to view the clip. The choice of size can be presented with smaller sizes for lower bandwidths and larger sizes for greater bandwidths.
Audio. Two factors to consider for the audio format are choosing an appropriate sound depth (eg. Stereo vs. Mono) and choosing an appropriate audio compressor (eg. i-Law, A-Law, IMA, etc.). The higher the quality, the longer it will take for users to receive the content.
Number of Users. As the quantity of users increases, the efficiency of Internet servers can drop. Users may wait longer to view the clips or not receive them at all. By utilizing effective optimization methods, this drop in efficiency will not occur as quickly, with a final outcome of allowing more users to use the extremely fast and high quality streaming system.
Streaming Audio will provide audio clips of radio advertisements, audio tracks, and interviews could also provide entertainment. This system should be implemented following the same rules of streaming media described above.
   Online Games

The site will feature a number of online games, bringing in elements from the commercials that are on the site. These games will also earn users points and will prompt users to view commercials to complete various games. For example, one game may be a “Where are they now?” trivia game, in reference to popular characters in advertisements. As mentioned before, another example is illustrated in FIG. 12, called Mascot Mania. Participants are asked to select the correct name of the mascot, the brand, the company, and the type of product it represents.

Community

A community site is one where users participate in the creation of content and develop a personal stake in activities that occur there. When a user participates with other users, they develop personal relationships. The personal bonds formed between users and the stake they have in their content cause users to return frequently.

The growth of a community is somewhat organic. As more users participate and add content, other users are encouraged to participate. For example, no one would post a question to an empty bulletin board, where no one else will read or respond to their post. However, message boards on hot, current and interesting topics are like a snowball rolling down a hillside. The community grows exponentially as more and more people participate.

To truly build a community, A2C needs to clearly define their users and present features those users would enjoy. Some potential features that would fuel the community aspects of A2C are celebrity guests, industry guests, and hot topics. US Interactive recommends that the following community features be included in the initial A2C Internet site:
Message boards will very closely resemble newsgroups in their implementation. Threaded message lists, posted responses, and user contact information are important aspects of any newsgroup functionality. Message boards will correspond to hot topics (such as tobacco advertising, or PETA's recent “Got Beer” spots), discussion of articles, and be used to implement the reviews and feedback for specific advertisements.
Live Interviews with industry figures or celebrity guests that are either textual in nature or posted in a message board or chat format.
Moderation should be considered for all community aspects of the site. As noted in the competitive analysis, abc.com bulletin boards had a problem with language usage and conduct, so recognition of this issue early is important.
   Points-Based Reward System

To promote participation in the site, rewards programs and partnerships must be used. A points-based participation system will drive traffic and promote continued use, and a partner program will drive participation and awareness to a larger audience. This functionality will be critical to encouraging participation on the site.

Registered users will earn points that they can apply to prizes offered at the site. A2C may partner with Thomson/RCA to offer merchandise on the site. Other partnering opportunities for A2C may exist with companies like Amazon.com, CD-Now, and MyPoints.com, by incorporating their participation in the rewards program. For example, users may receive $10 gift certificates to Amazon in exchange for 500 points.

Other

Surveys and polls. These forms of feedback can be corporately sponsored, internally used for data gathering, or used as part of partner program promotions. Surveys can be used as a feature that other sites can easily incorporate into their content, much like a banner ad.
Feedback topics should be current events, hot topics, and industry specific news such as the Orkin ad that caused people concern when they thought an actual roach was crawling on their television screen. Using topics of interest will generate repeat traffic and contribute to the overall sense of community at the site.
E-mail Delivery Engine. E-mails are sent to users when they become a member, new ads and content are added to the site, and special promotions are run. In many cases, such as when someone becomes a member, this e-mail delivery is done automatically by the site, without need for human intervention; in cases when content changes or promotions are run, the e-mails are typically sent out manually.
The e-mail delivery engine would essentially be in charge of creating and sending targeted e-mail to specific recipients. For example, e-mail alerts could be sent to people who requested to be informed when a new “Wuzzup” commercial is added to the Internet site.
Content Management Engine. A site the size of A2C will mandate a content management engine. New ads will constantly need to be added to the site. News articles and other textual content will be changing as well. All content must be approved by legal before the content manager uploads.
E-Commerce. A2C potentially has several e-commerce opportunities, although they will not be a major source of revenue for the joint A2C/AI venture. A2C can offer quick links from commercials to areas for purchasing audio or videos from or about the specific commercial. Partnering with companies like CD-NOW and Amazon.com can provide A2C the benefits of having one-click access to the merchandise, without the administrative overhead of dealing with the actual sales. For example: Next to a Chevrolet “Like a Rock” ad, there may be links to the audio CD of the “Like a Rock” song. This album would be for sale at Amazon and A2C would receive a portion of the sale. The link could be sponsored by the Chevrolet site, redirecting users for a cost.
Forum for Work. A2C can be used as a forum for the work created by members of the creative community. A2C can leverage the benefits of creating an advertising community and presenting a forum where interested participants can post their work.
Forum for Parody. Parody work has a focus on fun and mischief that is not concentrated on in the Forum for Work. All users should be able to rank amateur work, creating an arena of competition and interaction.
   Amateur Community
Resume Posting. A2C can allow members of the site to post resumes. This will create a highly concentrated marketable database of professionals in the advertising creative field.
Pay for Access. A2C may want to consider having incremental amounts of member resumes and portfolios available to the different viewers of the site. Literally, the more a member paid, the more access that user would get to resumes. A system like this would encourage amateurs to be active in the site in hopes of drawing attention from the professionals at the site.
Portfolios. Users may be given the ability to create their own homepages, essentially compilations of their work. In addition, A2C should consider professional reviews of amateur materials for A2C members. Again, some form of moderation would need to be in place.
Moderation. A representative from A2C would need to periodically scan all content or approve all content before it is published.
   Recommendation Engine

A proposed feature to A2C would be the ability for members to fill out a questionnaire to help the site recommend ads based on their answers, and to have the site learn their preferences based on how they rank ads. The questionnaire would primarily contain a list of ads, asking the member to rate them individually.

For example, if 99% percent of people who saw the first “Wuzzup” commercial liked the second, then anyone who said in a survey that they liked the first commercial would be recommended the second. The site could also send users an e-mail when an advertisement is posted that might appeal to their interests.

This gives a level of personalization, presenting recommendation lists of commercials that are tailored to a member's specific tastes. Also, it creates a level of interest in ads the site has predicted for a member, in that the member would want to check out and review the ad to see if the site was accurate in its prediction. It could serve as a great way to get information from members Without seeming intrusive.

As Internet commerce displaces traditional business models in the consumer media, marketing communications, and retail industries, A2C will offer a framework for reaching and directly speaking to a communication driven audience.

Greeting Commercials

A proposed feature of A2C that would be another way of cateogorizing ads, would be similar to how greeting cards are organized in a store. A2C categorize ads to suggest appropriate occasions in which to send specific commercials (“greeting commercials” instead of greeting cards). For example, the Nike advertisement with Michael Jordan explaining how many shots he's missed and how many times he's failed has the tagline “I fail, therefore, I succeed” would be categorized as motivational and/or send to colleague or friend who is facing difficult challenges at work or in sports.

User and Customer Behavior

User acceptance of advertising is the crux of A2C, and is the single greatest risk factor the site will encounter. Market demand for this service will be the deciding factor as to whether it is a success or failure. Although preliminary research has been positive, there is still risk in the unproven assumption that advertising is an entertainment medium that Internet users will not only accept, but will turn to frequently.

If the affiliate program becomes successful and drives large amounts of traffic, the affiliate manager will be unable to keep up with the time consuming activities of monitoring affiliate sites to ensure that they are following the terms of their agreement. It will also become too labor intensive to research and approve each affiliate for participation in the program. The following approaches may be used instead.
Monitoring System: If the partnerships or affiliates become too large of a group to manage, A2C will need to employ a rules based system for monitoring the network for violations of the membership agreement. It may also be necessary to open the affiliate network to electronic enrollment.
Remove Form. If requests to become an affiliate are severely backlogged, A2C has the option of removing the sign up information from the Internet site as a temporary stop-gap until a long-term fix can be found, or additional resources are put in place to process the requests.

A2C should be supported with strong traffic driving initiatives and promotions that encourage participation in the site. Internal focus groups and user testing should be conducted during the site's creation. Aside from the learning gained from these processes, A2C will have the added benefit of creating community content as the participants use the site.

Creating a community is a somewhat organic process and A2C will need to be flexible and creative during the process. It will be very important to analyze and react to user feedback on site features, as well as requests that they may have. Moderators of the community sections should also interact with the users of the site, responding publicly to requests that people may have. This shows that A2C is interested in the community and is there to support its growth.

In addition, A2C should prime the message boards with content. A “friends and family” initiative to create initial content and spark debate will also be useful. This would include people associated with A2C, and acquaintances that they can muster, participating heavily in the message board sections of the site to ensure that they are not left empty.

A2C must actively solicit agencies and advertisers to get copies of their advertisements. This may require some combination of promotional efforts in Advertising industry trade publications, direct marketing and personal sales efforts to spread the word about A2C and increase the number of advertising submissions.

For advertisers, the amount of effort required to convert an ad and send it to A2C is minimal. The free exposure, especially the site traffic is high, should be a strong benefit to advertisers, provided the value is communicated properly.

Whenever users are asked for personal information it must first and foremost be done so that all privacy or security concerns are allayed. A clear and easy-to-read statement is a must. Legal writing must be included somewhere on the site, but the first thing users see should be written in a comforting and straight-forward manner.

In addition, user information must be treated with the highest level of security. If confidential user information is ever compromised, the bad publicity could easily ruin a company such as A2C/AI.

Today's trend points towards a rapid growth in the use of broadband and rich media technologies, but it is by no means a given. However, other technology such as compression and streaming media are also making impressive advances, thus delivering more information over slower connections. The next few years should also bring the proliferation of IPv6, an upgraded Internet Protocol that functions better with streaming media and larger downloads.

Therefore, the risk of a slow adoption of broadband over the next few years is mitigated by the proliferation of alternative compression techniques and upgraded Internet systems and backbones that are currently taking place. The goal is to build a site that will allow people to be entertained by all types of commercial advertising: television commercials, radio, print, billboard, internet, etc. The consumers would be able to view the advertisements, rate them, comment on them, and create a community-like environment to further the exchange of comments, likes and thoughts about the work and the brands.

The site has no direct financial return—its goal is to allow people to have fun via various forms of advertisements. The goal is to entertain consumers, to get them to spend time on the site in a constructive way.
1. Get people to sign up on the site, giving personal information and details (demographic statistics).
2. Get people to rate the various commercials and offer opinions about them.
3. Get people to send commercials to their friends, thereby promoting the A2C Internet site.
   Get people to return to the site on a consistent basis to
   Internet site URL
      E-mail:

The e-mail campaign will take a different tact than the direct mail pieces. All e-mails will communicate relevant trends, advertising based-data, and other key communication concepts that will promote continued acceptance of the e-mails. Many companies, including Forrester and Consumer Reports, entice new clients to learn more about their research findings by using this type of communication. Ultimately, the e-mails will promote sign-up for AI's service offerings, and any potential seminars in their area.u

Trade Publications:

After the first 3 months, all trade communication will direct consumers to the Internet site for further details and information. For example, a two-page-advertising placement might cover the brand with the first page, and further explain the product offering on the second page.

Open Seminars

Seminars will continue to be offered during the first 6 months of the campaign, focusing on the initial primary markets. Online surveys will be conducted by those who took the seminars, providing feedback and information about ways to improve AI's services, and new services that customers may be interested in.

Sales Calls

Sales calls will continue to be an integral portion of the AI marketing strategy.

Internet Site

The Internet site should continue to evolve in terms of the amount of free, tantalizing tips that it puts forth.

The second 6 months will focus on secondary markets, with seminars in the secondary cities, and increased sales personnel to handle the new markets.

Business Use Cases represent the first pass at describing the functionality that USI will build for the Phase I launch of A2C. This type of analysis is important because the A2C Internet site largely drives this side of the business. By documenting who will use the site (system) and what they will do there, the entire business becomes clear.

Business Use Cases are based loosely on the Rational Unified Process, an iterative process for software design. They are modeled on a list of “actors”, who are the people that interact with the system, and “activities”, which are actions that the defined actors perform. In addition, Business Use Cases serve as the starting point for the next phase (Validate) in defining the functionality at the next more detailed iteration.

It is important to note that actors represent functions or roles, not people. In other words, a person may represent multiple actors. Each actor is described and then assigned a list of actions that actor may perform within the A2C system.

External Actors:

Ad agency: an ad agency representative who provides advertisements and searches for information and research.
Learn About Research—Agencies will look for information on how to receive research. Much of the content may redirect the agencies to AI.
Contribute Content—Agencies will be invited to submit articles that are interesting to consumers, avoiding trade industry style content.
Submit Ads
Contact A2C
Purchase Enhanced Polling—When Ad Agencies submit ads, they may purchase “enhanced polling” which allows several other questions to be directed to users instead of simply asking them to rank the advertisements.
Track Polling Results—Results from enhanced polling will be delivered through an agency-only Extranet on A2C.

Advertisers: a company who will sponsor the A2C Internet site through advertisements or logo placements.

Advertisers will have the ability/desire to execute all ad agency activities.
Sponsor—An advertiser may wish to sponsor an area, article, or promotion on the A2C site.
Find ad agencies—An advertiser can use A2C to find information on specific ad agencies, such as which agencies created which advertisements.

Partnerships: a representative from an e-commerce enabled company that will use A2C as a sales partner for their product.
Learn about programs—Companies and users with Internet sites may want to find information on becoming an affiliate of A2C.
Sign up for program—Companies/users wanting to become an A2C affiliate should have access to an online sign-up form. All potential affiliates must be investigated prior to approval.
Email inquiry—Contact representatives at A2C to learn more about a partnership.
Manage their account—Once affiliates, a company/user should have access, via password protection, to check their account, redeem accrued points (if applicable), change password, and cancel their affiliate membership.

Visitors: end-users who come to A2C who are limited to general areas of the site. These users have not registered to become members.
Become members—Visitors will need to become members to gain access to all the areas of functionality in the site as well as take part in on site promotions.
View ads—Visitors to the site may view/listen to ads.

4. Clicsee the latest and greatest additions to the advertisement library.

Who is the Target?

The key targets are 18-24 male/females and 25-49 male/females.

What do They Think Now?

Not applicable—there is no current opinion with this site.

What Should the Target Do?

The goal is to get the target to spend time on A2C, by rating advertisements, and promoting the site to their friends and peers.

How will A2C Persuade Them?

A points-based reward system will provide incentives to users. Points are awarded for rating and viewing commercials, promoting the site to friends and family and for participation in surveys and focus groups through AI.

What is the Personality?

Clean, fun, fresh, funky, inviting, entertaining, addictive and open.

Response Measurement:

The success of the site creative design and functionality can be judged on several factors:
Overall volume of traffic
Consistency of traffic
Repeat visitors
Number of sign-ups of friends and family by current members.
Identifying thought leaders to participate in research for the advertising industry.
   Marketing/Communications Plan

The marketing and communication plan for A2C revolves around traditional and non-traditional media.

While the Internet consumer cannot be targeted in the same way as traditional marketing, some of the tactics that we are going after will include the ability for A2C to target consumers demographically.

The currently identified primary markets include the top 25 major North American markets. The following are key markets in this segment:
New York
Chicago
LA
San Francisco
Toronto
Boston
Detroit
Atlanta
Ft. Lauderdale

Whether A2C is defined as an entertainment or as a community site, both categories face multiple competitors in an ever-growing online world. As well, the campaign strategy must recognize that while A2C must build a substantial audience, it cannot spend money that does not generate immediate and relevant audience numbers. The campaign must focus on building strong brand awareness through tactics that call the consumer into immediate action.

In order to achieve these goals, the marketing campaign must integrate guerilla-marketing efforts into all points of traditional marketing—aggressively merging both the online and the offline. Communication messages between guerilla tactics (such as opt-in e-marketing, and elevator advertising) must leverage all possible avenues for communications.

Summary of Plan

The proposed and recommended tactics are as follows:
Viral Marketing
   Refer a friend
   E-mail marketing
   Opt-in e-mail marketing
   Web based contests
Guerilla Marketing
   Interactive Elevator advertising
   Club Advertising
Traditional Marketing/Advertising
   Selected Television
   Magazine
   Selected Billboard/Video Billboards (in selected markets)
Online Advertising
   Banner Advertising
   Pay for results networks
   Partnerships
Future Possibility
   Theater Advertising
      Viral Marketing

The love bug virus may have caused untold damage, but most marketers can't help but admire the speed and ease with which it was spread.

Doing damage is not the goal of the marketing program that US Interactive is recommending. Viral marketing techniques are a key way to acquire new customers, gather information and build brand awareness, both quickly and at very little cost.

Viral marketing is really an online variation on word-of-mouth. It enlists both prospects and current customers to spread the A2C message. Participants in viral marketing often average 2.8 referrals per person.

Adding a Refer a friend option can often lead to double, triple, even quadruple returns.

Refer a Friend

Refer a Friend involves invoking both current and prospective customers to promote the A2C site without detracting from their participation. Refer a friend tactics will allows A2C to use both the prospective and current customers to drive multiple consumers to A2C.

Opt-in e-Mail Marketing

E-mail marketing will be one of the cornerstones of the overall campaign. E-mails should come from partnerships purchased lists or companies such as MyPoints or CoolSavings.Com that leverage e-mail addresses where users have opted-in to receive such communication.

Potential e-mail partners include:
socialnet.com
mail.com
postmaster.com
24/7 mail.com
   Web Based Contests

Web based contests are proven to increase the response rate to banners, e-mail marketing and other forms of viral marketing. They will be a key focus of the A2C viral marketing communication platform.

Guerilla Marketing

A2C has a need to reach a broad audience. This includes corporate individuals, general consumers, both young and old. The following tactics will also enable A2C to reach out to a broader audience. These tactics should be explored in the aforementioned major markets.

The recommended tactics are as follows:

Interactive Elevator Advertising

Elevator advertising has been around for a long time. Interactive elevator advertising, on the other hand, is rather new and extremely effective. Core buildings in metropolitan areas now have interactive LCD monitors that broadcast advertisements to the captive audiences travelling in the elevators. This advertising allows A2C to present sample commercials, the web site itself, and offers to drive consumers during the lunch breaks to participate in special online A2C contests.

Club Advertising

Part of building awareness includes leveraging different types of communication tools. The 90's brought the world club advertising, in a variety of examples—they include:
Post cards in restaurants
Bathroom advertising
Floor Advertising (advertising on supermarket floors)
   Traditional Marketing/Advertising
   Television (In Selected Markets)

Television advertising should be considered in key regional areas, using off-beat, well devised, humorous campaigns that draw the A2C target audience to the web site. Regional television advertising is relatively inexpensive, and allow A2C to leverage online contests for developing our own commercials. For example, users could be offered the ability to create the next A2C campaign, and win $10,000 in cash for creating the television spot.

Television usage would depend on the activities in the local market, and would leverage the largest audiences.

Magazine

Internet publications: Internet publications, such as Yahoo and Wired, among others, will be used to target the Internet audience for A2C. The growing mainstream ‘Internet connected’ audience may be reached through these strong monthly publications.
General publications, such as Maxim, Gear, Stuff, Details, Shift, Self, among others, will be targeted for reaching general audiences. Innovative concepts for general publications include inserts, tear-outs, etc.
   Selected Billboard/Video Billboards (In Selected Markets)

Billboard advertising is usually very cost effective, and draws a number of repeat viewings if it is placed in a heavily trafficked area.

Online Advertising

Banner Advertising: While the ultimate effectiveness of banner advertising continues to be judged, it is still one of the most relevant and familiar tools available to A2C today. Banners would be used on relevant community sites to increase brand awareness and recognition, but will not be used as a traffic-driving tool.
Rich Media advertising: As rich media services, A2C must leverage the broadband applications and benefits of rich media ad banners. These banners allow A2C to offer a dramatic increase in the amount of information it can offer to draw in viewers to the A2C site.
Pay for Performance: Banner advertising will be complemented by more pay-per-click advertising buys, sponsorships and other marketing techniques that are more cost-effective at driving traffic, but offer less branding power.
Thomson Properties: Thomson has the ability to promote drive traffic and build awareness for A2C by promoting it on Internet sites, displaying it through its online guides, packing a simple flier in all products shipped, or using other future channels that develop.
   Partnerships

Partnerships need to play a critical role in the marketing of the site. As online communities grow, it is important that A2C positions its type of entertainment on a number of sites, including sites such as I-Vllage, AOL, and Yahoo!, among others. Where possible, strong exchange relationships must be developed with partnership sites to ensure that the benefits go beyond the financial arrangement, and move towards mutual benefits.

Ad Insights.com (AI)

Business Description

The advertising industry is bringing advertisements to market faster, increasing the amount it spends on ads each year, and facing a public that is currently saturated with advertisements. While the intensity of this cycle has increased dramatically, the tools for evaluating the success of these very ads have struggled to keep up. In fact, the metrics have remained the same over many years—the success of an advertisement is measured by the amount of people who see the ad and how many times they see it.

AI brings a new type of research (called insights instead of research) to market specifically for the advertising industry. AI is a research service that uses the internet as tool, not a destination. Its goal is to provide effectiveness testing for advertisements through focus groups and surveys. The power of AI lies in its ability to rapidly and accurately test advertisements using people from all over the country that would otherwise take an inordinate amount of time. Advertisers need a new tool that is quick to market and can provide the quality of research they depend on.

The bulk of services focus on qualitative research (the emotions, the how and why) vs. quantitative research that is linear and requires critical mass. Services include, but are not limited to:

Thought Leader Access (targeted qualitative insights): The present inventors have realized that all opinions are not equal. There are individuals considered to be thought leaders. A thought leader is defined as a person who shares his opinion about a brand, an advertisement, a product, a service, or an experience with others. Not only does this extroverted person share his opinions, other seek out his opinion, and he is considered an influencer who can affect purchase decisions and brand reputation. Currently, advertising agencies have difficulty identifying these people even though they know they may exist. An even bigger challenge is the need to have direct access to these individuals. Currently, advertising agencies use data from panels in an attempt to identify thought leaders and evaluate their opinions, but the data are not aggregated and it is very time consuming.

A2C registration data, and users' comments in chat rooms and forums (in combination with other people's reactions to their comments) would identify these thought leaders (a.k.a., influencers). In one embodiment of the invention, these activities of A2C users may be automatically tracked so that though leaders may be identified. For example, a computer program may be used to keep track of the number of times a user participate in a web chat, number of times he or she actually spoke on a chat, or participation in other activities, etc. on the website. That is, by the frequency or time of his participation (active or passive) on the web site. In addition, the website may ask a user to nominate other participants that he or she regards as a thought leader of the website; or through self-nominations. Furthermore, the thought leaders may be identified through his or her registration process, that is, the more information he or she gives during the registration process, the more likely he or she is a thought leader.

System designers, anthropologists, sociologists, and psychologists may devise additional strategies used in registration questions/information, to properly identify these thought leaders. Unlike users on A2C, all participants in AdInsights research may be paid cash quarterly for their participation.

AI would utilize Thought Leaders using the following research tools:

Concept testing: typically, an ad agency only has 2 to 3 weeks to devise a pitch for a potential client or even existing one. More and more advertisers are “bidding out” their ad campaigns each year instead of forming a long-lasting relationship with just one agency.

Therefore, the ability to quickly test concepts (storyboards) would give an ad agency an advantage during these pitches as they could cite changes they made to a concept because of the testing conducted for the target market (for example, “we changed the gender of the main character to a woman as it created more humor and attention than using a man for our target market of men age 18 to 50,”). The ad agency would also be able to present several concepts to the client and tell them the strengths of each one (“This one tested high for humor and brand identification, but didn't do as well for “call to action,” for example).

Surveys, Focus groups or Phone interviews with AdInsights client: Another advantage of specialization and using the ad2cents website to build the database, is the sense of membership and partnership it creates with participants. Thought leaders would be paid, and understand that they might be asked to be interviewed over the phone about their comments in a focus group or their opinion of a concept, etc. In current testing, such one-on-one access isn't available to the research client. AdInsights would place all calls and be on the line to log the data, in order that they assist in “making sense” of the information and provide expert analysis for the client.

Mystery shopping: Thought leaders would be asked to shop for specific item. Upon their return, they would complete a survey or phone interview about their experience. An example of the value: an ad agency is preparing to launch a campaign for a frozen pizza. Other research from the advertiser shows women between 18 and 45 make up 80% of the people who purchase their pizza. AdInsights would schedule 10 to 15 thought leaders who meet this criteria to go to three stores and shop for frozen pizza. No brand would be specified. Upon their return, the participants would complete a survey about their experience. This data would enable the ad agency to proceed with an ad campaign and make appropriate recommendations about the consumer's buying criteria, brand loyalty, affects of point of purchase display, price, packaging, ingredients, etc.

Moderate chat rooms: Thought leaders would be asked and compensated for moderating chat rooms as a way to access data. Their purpose would be to engage other participants in conversation and dig deeper into issues that affect advertisers.

Participate/Lead Forums:

Thought leaders would be asked and compensated to participate in scheduled forums (which are like moderated chat rooms).

Adfusion: Proactive research that anticipates future platforms. Guides agencies and advertisers in creating a message that works on new and emerging media platforms such as eBooks, PVRs (personal video recorders—TiVo), etc.

Currently, ad agencies realize there is a platform (i.e., hardware and devices that deliver content and advertisements) revolution going on, but don't have a person dedicated to researching these platforms and finding the best way to deliver a successful message using these platforms. Advertising agencies do not enjoy the ineffectiveness of current internet advertising. Therefore, for example, Adfusion would leverage Thomson multimedia's expertise in this arena, to research methods that work on various platforms. For example, the surge in DVD Players, Pay-Per-View programming, and Personal Video Recorders (as well as internet usage), has changed people's TV viewing behavior (they only have so many hours in the day).

Adfusion would conduct research to find out what types of advertising work best: are sponsorships effective since TiVo enables people to skip over 30-second spots with a simple press of a button. Adfusion would also test product placement to find out what recall and effect this method has on targeted consumers.

Dual Radar (DR. Brand): Focuses on tracking brand health, for example. Uses dual methodologies to create a comprehensive report on brand image and placement. This service is the only one that requires critical mass as it falls into the quantitative research category.

Syndicated Research: studies that focus on one particular arena. Targeted clients are recruited to fund the study before it is conducted. Some of the information is used for general reports while the client receives a certain amount of proprietary research.

Reports: AdInsights will also generate monthly reports that provide general data about insights derived from A2C and analyzed by AdInsights researchers.

These service offerings fill the void in the creation of advertisements. Ad agencies currently have no effective and fast method for testing their concepts early in the development process. Researchers and advertisers also suffer from testing methods that fail to re-create the actual advertising viewing experience.

AI will employ market-leading research specialists that will participate in the creation and analysis of research results. This will differentiate AI from other Internet research sites that employ automated testing. High quality professionals will give AI a reputation for being smart, credible and reliable.

AI products help fill that gap. AI is an effective alternative to offline focus groups, especially when a clients' objectives can be met without the need for face to face interaction. The AI environment will allow for a new type of research in a potentially lucrative market. In 2000 alone, agencies and advertisers will spend nearly $52 billion on research.

Products and Services Definition

AI has three services: surveys, focus groups and the expert analysis. These services are assembled and marketed in packages to serve the interests of advertisers. Advertisers and researchers will have the ability to order specific packages of services that will address their research needs, providing them a more logical and intuitive product offering than is available elsewhere.

All of the research products from AI will have the option of targeting a specific demographic—an extremely important feature for advertisers concerned only with the specific demographic they are targeting with their advertisements. Clients will be offered the ability to select their target from a pre-defined “menu” of demographics, a concept suggested to USI and Thomson during interviews with marketing research specialists.

AI will aggressively target independent research companies that work with advertisers and agencies. These research companies will have the ability to re-sell all AI products under their own “private label.”

AI will provide these resellers with a margin on each sale, creating a vital value chain. Resellers will have an incentive to sell the AI product, and AI will be able to rapidly gain market share in the research industry as resellers work with multiple ad agencies and advertisers.

Customers will have the largest pool of participants available to them by selecting from a menu of demographics. However, they can narrow down the pool by selecting different variables such as age, sex, income, and region.

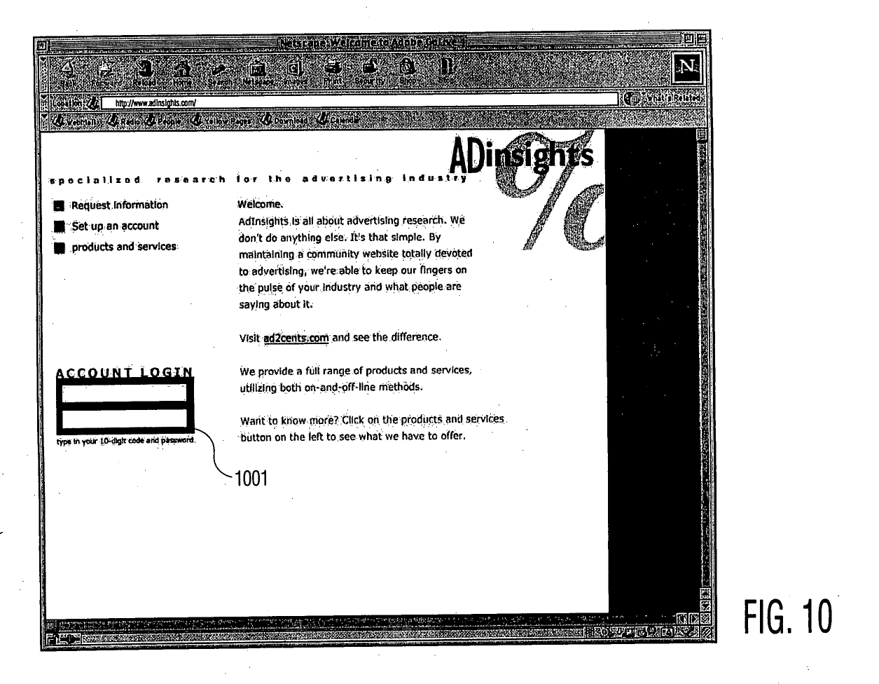

AI will divide the services into two main categories: Reports and Testing/Research Services. A subscribing client of this web site may access the web site by entering user login information 701 as shown in FIG. 10.

Reports

AI will release, on a periodic basis, reports concerning the marketing industry. These reports will analyze information gained through traffic data from A2C and non-proprietary AI research. The style and presentation of these reports will be very similar to Forrester Research Reports: succinct and high-impact, but written for the advertising industry.

The goal of the reports is two-fold. First, they will create a revenue stream for AI. All reports will be sold singly, or on a subscription basis. The other goal is to create awareness of the AI testing and research services. Although the revenues from this offering will be marginal, driving business to the AI research services will be critical.

Reports may be undoubtedly be passed along to other industry specialists, and may be used as sales tools. As industry specialists read through the reports and find value from the information contained in them, they will gain respect for the analysts at AI and will be more likely to use the AI product when they need research.

Because user behavior on A2 C will be fully measurable, the AI analysts will have access to detailed information on people's preferences for advertisements. This information can be used to create interesting reports that reflect on people's ad viewing preference and their opinions towards advertisements in general.

The reports may cover topics such as advertising trends, and the awareness levels of certain advertisements. Information on what user's find funny, how they react to certain imagery and what commercials they are seeking out will be very useful to advertisers. This information is also very time sensitive, as users' tastes for media change rapidly.

Each report should be delivered through e-mail and available through the AI Internet site. Information will be presented at different levels of detail. Users who have paid a higher access fee will also gain access to more detailed information, potentially drilling down into the actual data itself. In this way, the AI reports will be useful to multiple customers—from a 50,000 foot Account Executive view to the hands-on research analyst that wants to understand the data in detail. At the highest level will be the analysis of the data, supported with charts, graphs and diagrams.

Reports are based on the expertise of the AI analysts. In order for this to be successful, AI will need to hire the best and brightest in the field of marketing research. Analysts will spend part of their time creating these reports and the rest working on the surveys and focus groups created by customers.

Testing/Research Services

Surveys and focus groups will be packaged into several different service offerings, in order to better appeal to researchers and provide a consistent methodology and pricing structure to the services.

Each package will have additions and options that will be flexible enough to accommodate customers. Standard additions and options will be priced so that users may order them through the Internet site.

All tests that require active participation from users (survey and focus groups) will need to be supported through an incentive offering. The incentive will need to match the degree of participation and quantity of user's time needed for a successful test.

For example, points towards the A2C reward system may be enough to encourage people to take a 5-minute survey. In order to get people to participate in 3 surveys and an hour-long focus group, the value of the points offering will increase substantially or other compensation will be provided.

Full Commercial Development Testing

AI will offer a unique service to advertisers and researchers—the ability to test advertisements throughout the creative process and post-test an advertisement after it has run. Because the testing environment at AI is facilitated through the Internet, a test can be arranged in a fraction of the time it would take to mobilize an off-line test.

Another key benefit to advertisers is the ability to test advertisements using the same group of people. AI can recruit a large enough base of testers that a substantial number of them could participate in multiple surveys and/or focus groups over a short period of time.

For example, AI could recruit seven hundred testers to test an advertisement concept at several key points: positioning statement, story boards, and final draft. At the end of 4 weeks, when the final test is concluded, AI could have had 500 people participate at all three points. The data that advertisers gather from these tests would be invaluable.

The advertisements, storyboards, or positioning statements will be viewed through the Internet site, utilizing the same technology that A2C uses to present its advertisements. Users will then be presented with a series of questions if they are participating in a survey.

An experienced research specialist should facilitate Focus Groups. These may take the form of controlled chat rooms (where the facilitator controls the flow of communications). The actual method for testing will need to be developed in conjunction with the research analysts in order to ensure the credibility and validity of the research.

Brand Health Reports

Conceptually, advertisers lack a method to test the health of a brand. Brand health is measured through awareness, recall, association and general perceptions of the brand. Overall brand health is the sum of user's perceptions of a company (brand) at every touch point or interaction.

AI will offer services specifically targeted towards creating a brand health report. This service will be the result of combining AI reports and specialized research. These reports and services will offer a client a detailed brand analysis, which will include the following: brand awareness (based upon the client's target audience), brand perceptions (based upon key indicators), and reviews of the brand in comparison to key competition.

Expert Analysts

Although not a traditional product or service, the expert opinion of marketing research specialists will be an invaluable asset to AI and a high-quality service to its customers. All of the AI research products will come with the option of consulting from the expert AI analysts. This includes pre- and post-research consulting and analysis. Because of the research reports that AI will release, its analysts will become well respected and admired in the industry.

Future Considerations

As the AI product evolves, different opportunities for marketing research services will surface and AI will need to capitalize on them. While brainstorming the products and services within AI, US Interactive developed three concepts for products and services that should be considered after the core offerings (surveys, focus groups, and reports) have been well established and demand for these services has been confirmed.

Product Placement Testing

Product placement is the inclusion of branded items within a movie or television show. The creators of the entertainment piece receive payment for the inclusion of their item in the piece. For example, the Ford Explorers used in Jurassic Park were paid for by Ford and the actual vehicles given to the producers.

This type of promotion can be very expensive, depending on the popularity of the movie or show that the placement occurs on. Advertisers and researchers are very likely to want to measure the return on their investment and determine what value the placement had.

AI could provide a forum for this type of testing, presenting users with the entertainment piece that includes the product placement and using a testing method to evaluate its effectiveness.

Currently, US Interactive recommends that this idea be tabled until the larger research services have been established for several reasons:
The presentation of near-cinema quality film (necessary to see most product placements) would require an enormous amount of bandwidth and rules out delivering spots via the Internet site.
Alternatives such as asking participants to go view a movie suffer from many logistical problems.
There needs to be a clear methodology to determine if the spot was effective or not.
The field of product placement is minute in comparison to broadcast advertisements, so there is less revenue to be recognized in this area.
   The Sample Show

Current testing methods may fail to recreate the actual advertising viewing scenario. In other words, 10 people around a table viewing a one-minute advertisement during a focus group is fundamentally different than a commercial break during the middle of a prime-time show. To that end, the present inventors have developed a concept dubbed “The Sample Show.”

The Sample Show will more realistically recreate the advertisement-viewing scenario by mailing people videotapes containing a clip from popular shows with advertisements included in the appropriate time blocks. After viewing these tapes, users would be asked to participate in a survey or focus group, via for example a web site such as A2C.

Logistically, AI may outsource the creation and distribution of the videotapes in order to reduce costs and provide high-quality service. However, evolving technologies make it very likely that alternate distribution methods will be more effective than videotapes in the near future. DSS, GeoCast and Interactive TV are all possible candidates for future broadcast channels for the Sample Show service.

While there are advantages to this concept, there are some drawbacks. The environment may be more natural, but it is also less controlled and could yield unreliable results. This testing method would also increase the time it takes to get results.

Site Functionality

The Internet site will serve as the focal point for AI products. It will be the foundation on which the analysts communicate and interact with the AI customers. Part of this system will be the electronic customer relationship management (e-CRM) package, described below, through which all customer interactions are documented, referenced and mined for data.

The purpose of this section is to describe the “system” that encompasses AI. Portions of this system are likely to overlap with A2C. It is recommended that these two sites share a common infrastructure, with two different Internet sites. In other words, the two sites will look and behave somewhat differently, but will be driven by the same core databases

All of the research conducted by AI will be done through mainly two types of tools: surveys and focus groups. These tools will both rely on the presentation of advertisements to the research subject. This presentation will use the engine created for A2C.

Surveys

Surveys will be conducted through an Internet interface. This will allow customers (agencies and researchers) to enter the types of questions (multiple choice, free response, ranking, etc) and then enter the question text. After an entire survey is created, the contents are forwarded to an analyst at AI for review and editing. The analyst compares the questions against the goals and objectives the agency or researcher is trying to accomplish.

The review process will include e-mailing the researcher when the survey has been reviewed and notifying them that the results are ready. Researchers will then be able to read and accept, reject or discuss the edits with the reviewing analyst.

Once the survey has been created, an e-mail will be sent to participants, soliciting their participation in the survey. Participants will then view the advertisement and participate in the survey. Survey results are available in real-time to the researcher and analyst, using reporting tools that automatically generate results from the poll information.

The reporting tools will also enable researchers to perform cross-tabs on different pieces of data, information that is critical to analyzing numbers, and allow for export and download of different database formats.

Focus Groups

Focus groups, like a survey, will consist of a creation stage, with the end result being a focus group guide. Because focus groups require a great deal of teamwork between the researcher and the moderator, this will be a more hands-on process. The moderator/analyst will be more involved with the researcher than they would be for a survey.

After the guide has been approved, participants will be solicited for the focus group. The actual focus group will occur in an interactive environment that must include several key features:
Advertisement must be able to be displayed, or “pushed” to the participants at the moderator's will. It may be necessary to show the advertisement several times throughout the discussion, or to show different advertisements.
The client and moderator/analyst must be able to communicate directly, outside of the discussion group. The group should not be aware that the research/agency people are logged on.
The actual discussion should take place through a chat (text) enabled environment that the moderator has complete control over. The moderator can mute and log-off users from the system.
Questions can be targeted to specific individuals or the entire group.
The moderator and client also have the ability to review everything that has been said, keeping a running transcript.
   Content Management

The delivery, interactivity and analysis of content is fundamental to AI. User behavior is tracked, A2C members add comments and take polls, researchers create surveys and analysts publish their findings. At all points that this content is being created, managed, or delivered, there will be a central content management tool that controls these interactions.

The content management system will display interactivity inherent to the analyst's reports. These periodic reports will be accessible after a user has bought or been given the rights to them. Each report will contain, at its highest level, the analyst's summary and insight into the topic at hand. Users will have the ability to probe deeper into the data, driving down into the statistics and raw survey results if they so desired.

Commerce Engine

Researchers and agencies will need the ability to purchase products and services through the Internet site. For customers accessing through the Internet site, this will require a system able to tabulate pricing based on the services requested, calculate any corresponding taxes, accept payment (through credit card or invoicing for larger clients), and interact with e-CRM features of the system. The customer service staff must be able to access and modify all customer data and service transactions.

This commerce engine can also serve as the foundation for, or interface with a full accounting system.

Demonstration

AI must have a public Internet where researchers, agencies and advertisers can view a demonstration of the AI products and services. This will include sample reports and interactive demonstrations of focus groups and surveys. The demo area will also include the ability to chat with or receive a call from a live customer service representative at any time, utilizing the existing call center and existing Internet technologies.

e-CRM

Electronic Customer Relationship Management describes a system concept that crosses all of the existing functionality sets. At its core, this system must document every touch point with a customer into a dynamically accessible record. The goal is to identify opportunities, needs, errors, problems, and create a communication framework that leads to successful client engagements.

The e-CRM system must be tied into every aspect of communication. All sales calls, customer service inquiries, client purchases, and outgoing communication will be logged in the same system.

The record of every sales call is available next to detailed information about a customer, developed over the sum of transactions with that customer. This record allows AI to better communicate with its customers, better target them with offers, and better provide customer service when an analyst or customer service representative is helping them with their research problem.

The primary goal of AI is to build a brand that sells research related services to advertising agencies, research companies and, ultimately, advertisers.

With the speed of business constantly changing and advertisers looking for timely and effective ways to test potential advertising, AI will be a key source of television campaign testing to:
Influence advertising agencies to sign up for AI services, preferably to blocks of services.
Influence research firms to sign-up for AI services, and ensures that AI becomes the dominant online research partner of the research firm.

One of the key targets are advertising agency account and strategic planners, and advertising industry research firms.

Current forms of research (focus groups, surveys) take a long period of time to complete, do not offer direct consumer feedback in an effective manner, and are costly for the value of the research returned.

By demonstrating the value/speed of AI's product offering, and how their client will ultimately view the service as a value-add of the agency or research firm itself.

Clean, professional, advertising experts, effective, well trained, focused, quick, technologically advanced, human-accessible.

The tone and manner of the execution must speak to people in the advertising industry. The communication must address the fact that AI is extremely knowledgeable in television/general advertising research, and that the staff is composed of professionals in the industry.

Response Measurement:

The success of the site creative and functionality can be judged on several factors, including:
Sales inquiries for AI services and products.
Quantity of actual sales.
Quality of actual sales.
Traffic on the demonstration site.

In order for AI to be successful, it will require a large database of active users that are interested in participating in surveys and focus groups. To achieve this critical mass, A2C must be successful in creating an active and dynamic community. US Interactive strongly recommends that Thomson evaluate Ad Critic and Insight Express as potential acquisition targets. These sites offer immediate access to a base of user traffic and/or a database of registered users.

AI should schedule its launch 90 days to 6 months to allow for the successful launch of A2C and population of the user database.

The research done by AI will not be considered statistically valid in the strict sense of the word. The results will be skewed because users are drawn from an Internet audience, and also from people who prefer advertisements. The Internet audience typically provides a more tempting market for advertisers anyhow, because users are typically better educated and have a higher income than the average population.

This sampling of users is different from statistically valid research that attempts to get as unbiased an audience as possible to provide a clear picture of what the entire population thinks.

While this excludes AI from predicting the results in the next election, it does not preclude valid, useful results for testing advertisement concepts. In fact, the research has several advantages.

Users of the Internet currently present more desirable targets for advertisers because they tend to have a higher household income and are better educated. Users who respond favorably to advertisements are much more likely to see and remember advertisements that are broadcast. Therefore, advertisers will see a benefit to targeting this specific group of users.

AI should be up-front about its testing methods and their strengths and weaknesses. AI will be different than statistically valid sampling and polling. It will provide more candid, real-time results from higher-profile consumers who are actively interested in receiving the advertisements.

All of the research services and products available through AI may have different pricing such as a flat rate. The services and products can be determined and ordered directly through the Internet site. Resellers and large corporate clients will receive a margin on bulk sales, but the price will not normally be discounted.

The method for marketing and communications plan for AI must be a tightly organized and e-CRM driven execution. The level of success for the strategy should be very high, given. AI's knowledge of the target audience, and level of understanding of the industry. As previously mentioned, AI will operate sales forces in key regions only, supporting secondary markets via air travel, phone, and direct mail communication. AI will execute an integrated, tightly organized campaign that focuses on relationships, and one-on-one contact instead of the usual marketing tactics. This ability to focus on a narrow market, is another benefit of specialization as it pertains to keeping marketing/sales costs low.
Direct mail or email
Internet sites (a2c and Adinsights)
Trade magazines
Direct sales calls and presentations
Open courses and seminars
Private courses and seminars
PR (creating a buzz)
   Direct Mail

AI will direct mail each major advertising agency, targeting both the account directors, and the key research personnel with a communications piece that offers a tremendous amount of information, and directs the client to take an online tour of the site features and services. The client will be able to sign up for an individual demo (if their offices are in the primary target cities, or sign up for a demo in the closest city—more details to follow). Alternatively, the consumer can call the 1-800 number to talk to an internal sales representative.

E-mail

AI will e-mail each major advertising agency, targeting both the account directors, and the key research personnel with a communications piece that offers the same as the direct mail communication, but the e-mail will be a much shorter, to the point form of message. It cannot be a lengthy e-mail; rather it must be written to suit the medium and the audience.

Trade Publications

For the first 3 months, the key advertising publications, including Advertising Age, Ad Week, Marketing, Strategy and other relevant publications, would be targeted.

The first month of the publication will be initial brand communication, with a clear message delivering the core set of services. The message must be direct and honest, since the target audience is in the business of selling and persuading the public.

The second and third months will offer dates and times for upcoming seminars, to demonstrate the service offerings in person. Further details on these seminars are below.

Open Seminars

The seminars, which people can sign up for using the Internet, 1-800 service or direct mail replies, will put the product in front of the research minded audience that is the target audience. The seminar, conducted in major hotels, is a great way for AI to effectively communicate and demonstrate AI's capabilities to a vast array of advertising consumers. Many in the industry are used to attending these types of demonstrations, with their competitors sitting right beside them. The advertising community is a close knit audience, with little hesitation to attend conferences, functions, and seminars together.

Seminars will also allow AI to showcase its research specialists, who will be able to converse with their potential customers.

Sales Calls

The sales calls will only begin after 30-45 days of direct mail and e-mails, so people have had the chance to examine the product and review the material.

They will follow standard business protocol, with the ultimate goal being an in person meeting with the strategy/research department for a demonstration.

Following the successful demonstration, agency personnel will be given the numbers of both a sales and customer service representative, so that the sales process will not be interrupted by a sales person being in a demonstration or a seminar.

All sales activity will be logged in the e-CRM system, to ensure consistent, organized communication.

Internet Site

As previously mentioned, the Internet site must launch with full demonstration capabilities, including sample reports, interactive demonstrations of focus groups and surveys, and the ability to communicate with a live operator/person at any time.

Overall Strategy:

The first 3 months were used to put forth the overall concept and service offering to make sure the message was clearly received. The second 3 months must heavily focus on communicating the potential benefits of the service using case studies, sample ideas for using the service, and tips on conducting better research. This strategy must be heavily applied with all of the potential tactics, ensuring a successful penetration of the target audience.

All of the previously mentioned tactics would be used, in the following manners:

Direct Mail:

The direct mail pieces must be customized to the individual, where possible. They must scale down in size, while increasing frequency. For example, post cards may communicate relevant statistics or tips on how to conduct faster, better research concepts.

All direct mail pieces will carry the appropriate communication (where relevant):
Sales representative and contact information
   1-800-number for the appropriate region k-through to affiliate—Visitors who like a particular soundtrack or movie will have the option to purchase them on an affiliate site through a framed section of the A2C site.
   Visit sponsors—Visitors will have the ability to click through to a sponsor's Internet site if applicable.
   View ratings—Ad ratings will be viewable to all users of the site.
   View reviews—Ad reviews will be available for viewing for all users of the site.
   Sort/search—All users will have the ability to sort/search for ads by company, ranking, genre/category, date, and keyword.
   Send to friend—All users will have the ability to send ad links to anyone they wish.
   Contact A2C—All users will be able to contact A2C.
   Learn about A2C—All users will be able to learn about A2C.
   Learn about focus groups—All users will have the ability to learn about focus groups.
   Work for A2C—All users interested in working for A2C will be able to access employment information through the employment section of the site. Here, users will have the ability to submit their resume electronically.
   Polling—All users of the site will have the ability to partake in online, user-centric polls.
   Sign up for affiliate program—Users wanting to become an A2C affiliate will have access to an online sign-up form.

Members: visitors who register with A2C will become members. Member will have access to more interactive onsite functionality as well as the ability to partake in special promotions.
All visitor activities—Members will have the ability/desire to execute all visitor activities.
Earn points—Members have incentives to interact with the site/community by accruing points that may be redeemable for certificates or prizes.
Rank Ads—Members may rank, or vote for advertisements.
Write a review—Members will have the option of writing reviews/opinions for viewed ads.
Respond to a review—Members may to respond to other members' reviews.
Participate in a focus group—Members who wish to participate in focus groups can submit their information to A2C and be part of the focus group waiting list.
Manage your account—Members will be able to check their account, redeem accrued points (if applicable), change their password, and cancel their membership.
Chat/forum/interview—Members will have access to chat/forum rooms for special events that may include high-profile guest stars.
Post an ad—Members wishing to show off their advertising skills may post their ad to A2C.
Create list of favorite ads—Members may create a list editable favorite ads that they can refer to and share with friends/users.
Download ads/offline content—Members will have the ability to download advertisements for offline viewing.
Personalize content—Members will be given the option of personalizing dynamic content catered to their interests. This may include changing the interface, color schemes, or choosing categories of advertisements to be displayed by default when they log into the system.
Play games—Members will be given access to online ad-centric games, such as Trivia.
Message boards—Members will have access to write/respond/communicate through the A2C message board. The message boards will be delimited by topic, ad, company, etc.

Media: A person who is looking for corporate information about or contact information for A2C for the purpose of publication, review or commentary.
Learn about A2C—PR and media will want to learn about A2C and its services/offerings.
Contact A2C—PR and media will want to contact A2C for additional information and interviews.
Request media kit—PR and media will have the ability to send online requests for A2C media kits.
   Internal Actors

Creative director: The person responsible for assembling creative content and approval of production content
Approve new page templates—when new pages are created the CD will approve integration with A2C.
Create new images—create the necessary images for A2C.

Copywriter: The person responsible for the creation, modification, and staging of the written content that appears at A2C
Edit copy—perform changes to the A2C copy text
Post stage content—place new copy in the staging area for final review and upload to A2C
Create Copy—produce copy for A2C
Create E-Mail—Write targeted e-mail content for e-mail campaign management system

Content manager: The person in charge of changing, removing and making approved content available on the A2C Internet site.
Post legal, approved content—integrate content from staging area to the active server.
Change/delete approved content—integrate revisions with active server
Request New Content—when content is incomplete place request with the content's author

Sales manager: The sales manager will coordinate, enter and manage all sponsorships on A2C.
Manage Sponsorships—add and remove new sponsor logo information, subject to content manager's approval.
View Sponsorship Performance Reports—the manager will need to track information such as sponsorship views and click-throughs for billing purposes.

Affiliate manager: The person in charge of arranging, managing, and contacting affiliates to the A2C site.
Remove, Edit, and Create Affiliates—manage affiliate accounts
View Affiliates—view affiliate accounts
View Affiliate performance—view information such as views and click-throughs
Approve New Affiliates

Coders—maintain the custom software portions of the system
View—source code
Edit—source code
Delete—source code
Create—source code
Access Staging System: upload and download code and binaries

Tech support: The person who will act as the customer support agent for technical issues.
View event log—analyze server generated event log
Respond to request—field all technical requests
View requests—browse technical requests
Manage Tech request log—manage request log sent form customer service representative.

Systems Administrator: The person who will manage access, usage, and maintain the system hardware
Manage Internet server—maintain and control operations of Internet server
Manage accounts—manage access to the servers and databases
All tech support duties—all duties of tech support

Data entry: mass entry of data through the Internet site
Input/modify new accounts—create user accounts and edit attributes
Mass Data Entry—Aggregate data sources with existing data

Reward manager: The person in charge of the A2C rewards program. Their duties will include full administration, maintenance and promotion of the reward program, as well as the participants
Fulfillment—handle prize delivery
Create promotions—initiate all aspects of promotions (prizes, sponsors, rules)
Manages the rules—enforce regulations of program
Manages accounts—edit, create, and delete rewards users
Manages/creates rewards partnerships—est. external partners for prizes

PR: the person who will handle information released to the public about A2C
Manage press releases—Add and remove press releases, specific to A2C

Marketing: the person who will handle general promotion of A2C
Manage marketing campaigns—maintain external contacts and internal resources as applicable to the marketing of A2C

Legal: the person attending to legal issues of A2C
Approve/disapprove content—approves all content for release on the A2C site
Create and Stage disclaimer info—provide necessary legal information for general site use

Censor (moderator): the person monitoring use content for A2C
View message board postings—browse entries
Deletes message board posting—manage content on MB's
Ban user—remove users who violate their membership terms
Warn user—initiate first contact with users in violation of their membership terms

Customer Service Representative:
Read inquiry—review incoming messages form A2C Internet site
Respond to inquiries
Redirect to internal resources—manage information flow to appropriate sources
Manage Request Log

External affiliate manager: the person who will develop affiliate relationships with external partners
Creates/manages external affiliations—maintain accounts
Link product—maintain click through information for affiliates
   System Architecture

FIG. 6 illustrates an exemplary system architecture for implementing the present invention. The architecture reflects the known internet based world wide web. A user or consumer, for example, may access the A2C web site from anyone of the terminals 301-1 to 301-n connected to the internet 310. The community web sites 302-1 to 302-n according the principles of the present invention are also connected to the internet 310, and may be hosted by one or more computers or web servers, as well known in the art.

Likewise, the research sites 303-1 to 303-n are also connected to the internet 310 and hosted by one or more computers or web servers. In addition, a client subscribing to the respective research site may access the research site via one of the terminals 301-1 to 301-n connected to the internet.

It is to be understood that the embodiments and variations shown and described herein are for illustrations only and that various modifications may be implemented by those skilled in the art without departing from the scope and spirit of the invention.

1-14. (canceled)

15. A method for transmitting video based media to a user through an Internet based connection comprising the steps of:
selecting a resolution of the video based media to be transmitted from a plurality of resolutions, wherein said selection is made in response to a user request of the video based media from a plurality of selectable video based media and a connection type of a user;
selecting a display size of the video based media from a plurality of display sizes; and
selecting an audio format for audio playback from a plurality of audio formats to accompany the video based media to be transmitted.

16. The method of claim 15, wherein said audio and video based media are transmitted to said user.

17. The method of claim 15, wherein said user selection of the video based media is made via a website.

18. The method of claim 17, wherein the selection steps are made in view of the number of users accessing said website where resolution of the video based media to be transmitted becomes smaller as the amount of users accessing the website increase.
